(19) United States
(12) Patent Application Publication
(10) Pub. No.: US 2010/0154716 A1
(43) Pub. Date: Jun. 24, 2010

(54) PET CRATE LINER PAD

(76) Inventor: TERESA A. SMITH, West Alexandria, OH (US)

Correspondence Address: James Ray & Associates, 2640 Pitcairn Road, Monroeville, PA, 15146, US

(21) Appl. No.: 12/538,482

(22) Filed: Aug. 10, 2009

Related U.S. Application Data
(60) Provisional application No. 61/087,353, filed on Aug. 8, 2008.

(51) Int. Cl. A01K 29/00

(52) U.S. Cl. 119/169; 119/170

(57) ABSTRACT

An absorbent pad for pet crate liners includes a bottom layer of liquid-impermeable film; a middle layer of liquid absorbent material having a first predetermined thickness; a top, non-absorbent, flexible foam layer having a second predetermined thickness and a plurality of apertures; and an elastic band engaged with the peripheral edges of the bottom and top layer.

### CROSS REFERENCE TO RELATED APPLICATION

This patent application is related to and claims priority from U.S. Provisional Patent Application Ser. No. 61/087,353 filed Aug. 8, 2008.

### FIELD OF THE INVENTION

The present invention relates, in general, to absorbent padding for pets and, more particularly, this invention relates to an absorbent pet crate tray liner with a perimeter securing means.

### BACKGROUND OF THE INVENTION

Prior to the conception and development of the present invention, there have been numerous types of absorbent pads for pet habitats to absorb animal wastes and sometimes even the associated odors. Some of the most common are absorbent pads for use during house training of puppies. These typically have two or three layers with a thin water-proof film on the bottom and a very absorbent pad on top of this. However, the common use for such pads has the pet leaving it after soiling it, not lying on top of it. When a pet is left in an enclosed crate for many hours, it could end up lying in contact with wet urine.

Numerous prior art example exist for articles addressing similar pet problems. For example, Morris et al in U.S. Pat. No. 4,779,566 discloses a disposable receptacle for animal waste having an absorbent material inside a rigid container, all of which are disposable. Engel in U.S. Pat. No. 6,223,688 discloses a litter box liner consisting of a sorbent layer sandwiched between a fluid-impermeable layer and a claw-resistant layer.

Yananton in U.S. Pat. Nos. 4,640,225, 4,469,046, and 4,869,204 discloses several variations of three-layer litter box liners, with the top layer always being a claw-resistant screen. These liner are not intended for having a pet lying on them for extended time periods, hence the comfort of the top layer is not a consideration. Johnes in U.S. Pat. No. 7,258,077 also discloses a litter box liner, but in the form of a bag.

Dryfur.com sells a pet crate liner for travel crates that is absorbent and has a comfortable top layer, but it also has its own rigid foam core. The whole tray is disposed of after a period of travel with the pet. Because it is rather expensive and not compact, this product is not practical for everyday use. Numerous types of pet pads for house training and incontinence are readily available commercially, but these could all be readily dislodged by a pet inside a crate. Hence, there is still a need for an inexpensive multi-layer absorbent pad that can be secured to a pet-crate liner so as not to be readily dislocated by the animal and yet be comfortable to lie on for hours.

### SUMMARY OF THE INVENTION

The present invention provides an absorbent pad for pets including a bottom layer of liquid-impermeable film, a middle layer of liquid absorbent material having a first predetermined thickness, a top non-absorbent flexible foam layer having a second predetermined thickness and a plurality of apertures, and an elastic band secured to the peripheral edges of the top and bottom layers.

### OBJECTS OF THE INVENTION

It is, therefore, one of the primary objects of the present invention to provide an absorbent pad that can be readily secured to the tray in a pet crate for absorbing pet waste products while avoiding waste contact with the pet.

Another object of the present invention is to provide an economical pet tray liner that is absorbent yet isolates the pet from spilled or waste liquid.

Still another object of the present invention is to provide an economical absorbent liner for pet crates that is not readily torn off by the pet.

Yet another object of the present invention is to provide a low-profile absorbent pad for lining pet crate trays such that the tray may still be slid in and out of its opening.

An additional object of the present invention is to provide a low-cost disposable three layer absorbent pad for use with pets.

In addition to the various objects and advantages of the present invention described with some degree of specificity above, it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partially cut-away perspective view of the present invention supported on a removable tray from a pet crate.

FIG. 2 provides a cross sectional elevation view of a corner portion of FIG. 1.

FIG. 3 is an underside perspective view of the present invention in place on a pet tray liner.

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

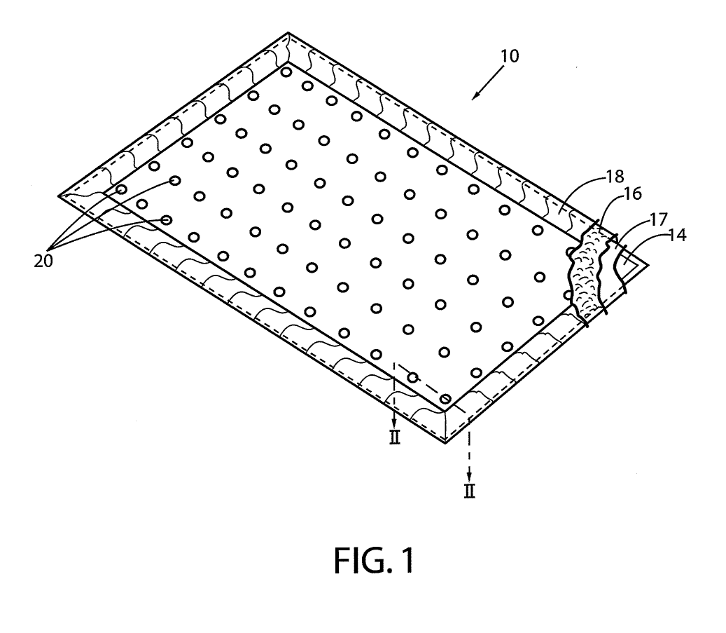

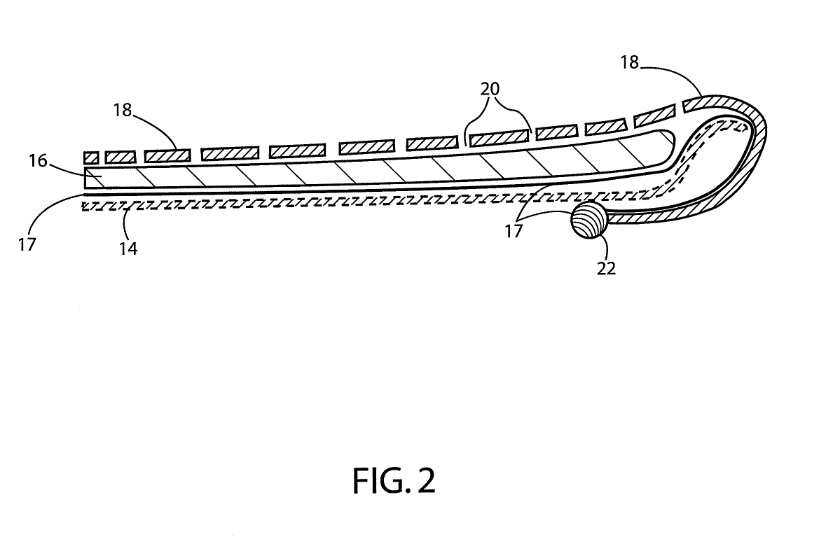

Referring initially to FIG. 1, the present invention, generally indicated as 10, is shown in a perspective view with a partially cut-away view of one corner. The three-layer pet crate liner pad 10 is shown installed over a conventional shallow tray 14 from a pet crate. The layer closest to the top surface of the tray 14 is the liquid-impervious film 17, which would typically be a polyethylene film of one-half to four mil thickness, but numerous alternatives would also suffice. The absorbent layer 16 rests above the impervious film 17 and coverage by layer 16 is over the entire flat portion of the tray 14 and most of the impervious film 17. Preferably this middle layer 16 is made of a superabsorbent polymer similar in thickness and type to that commonly used in disposable diapers and various sorts of absorbent pads. Typically, the absorbent layer thickness is between about 0.1 and 0.5 inches. Alternatively, the absorbent layer could be a paper pulp or pulp starch material. The middle layer 16 and the edges of the tray 14 are covered by the top layer 18. This top layer 18 is substantially non-absorbent and may even be hydrophobic so as to not retain any liquid. It has a plurality of perforations 20 spread out over the surface to allow waste liquids or spilled water to get to the absorbent layer 17, which holds the liquid away from the body of the pet lying on the top layer 18. In order to provide separation between the body of the pet and the absorbent layer, as well as a comfortable surface, the top layer 18 is preferably a flexible foam layer 2 to 5 millimeters (mm) thick. Flexible polyethylene foam of the type commonly used for hardwood floor underlayment would be a prime example. One potential supplier is the Pregis Corp. in Deerfield, Ill. This polyethylene foam is generally tough enough to preclude easy tearing by the pet, but still sufficiently resilient to provide a comfortable layer. The area of detail shown in FIG. 2 is indicated by II-II.

FIG. 2 provides a partial cross sectional view near one edge of the present invention. The tray 14 to which it is attached is shown in dotted outline. The impervious bottom layer 17 lies on top of the low-profile tray 14 and wraps around and beyond the edge. The absorbent layer 16 is on top of bottom layer 17, but coverage by layer 16 is only slightly greater than or equal to the generally flat surface of the tray 14. This is so that the low profile of the tray can be maintained for sliding in and out of the slot in the base of the animal crate or cage. The perforated top layer 18 sandwiches the absorbent layer 16 between it and the impervious bottom layer 17. The flexible foam top layer 18 extends over and beyond the outer edge of the tray 14, and the peripheral edge combines with that of the bottom layer 17 and the two are bonded to an elastic band 22 around the perimeter of each layer with the elastic band 22 underneath the tray 14. The perforation can be one of many shapes such as circles, ovals, hexagons, or rectangles. Typically, the diameter or equivalent diameter is between about at least ⅛-inch and one-half inch. The equivalent diameter can be determined by dividing the perimeter distance or circumference by n. The plurality of apertures 20 creates a percent open area in the top layer of between about 10 and 50 percent. The elastic band 22 is secured to the edges of the top and bottom layers, 17 and 18, by means such as sewing, gluing, melt bonding, or any other practical method.

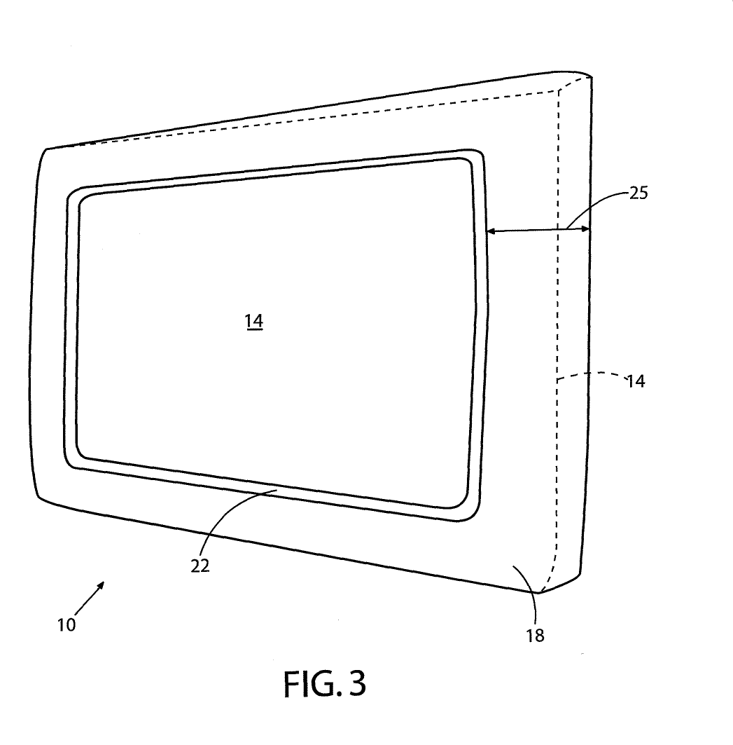

FIG. 3 provides a perspective view of the underside of a pet crate tray 14 with the present invention 10 installed. The outer edge of the flexible foam top layer 18 is sized such that when joined to an elastic band 22 around the periphery, it covers a substantial portion of the back of the tray 14. A typical separation distance 25 from the edge of the tray or the edge of the middle layer to the elastic band is at least three inches, but may be even more. The peripheral portion of the foam top layer may be perforated like the rest of the top portion is, but this is optional.

While a presently preferred and various alternative embodiments of the present invention have been described in sufficient detail above to enable a person skilled in the relevant art to make and use the same, it should be obvious that various other adaptations and modifications can be envisioned by those persons skilled in such art without departing from either the spirit of the invention or the scope of the appended claims.

What is claimed is:

1. An absorbent pad for pet crate trays comprising:
a) a bottom layer of liquid-impermeable film;
b) a middle layer of liquid absorbent material having a first predetermined thickness;
c) a top substantially hydrophobic flexible foam layer having a second predetermined thickness and a multiplicity of apertures creating a predetermined percent open area in said top foam layer; and
d) an elastic band secured to peripheral edges of said bottom and top layer.

2. The absorbent pad for pets, according to claim 1, wherein said first predetermined thickness of said middle layer is between about 0.1 and 0.5 inches.

3. The absorbent pad for pets, according to claim 1, wherein said second predetermined thickness is between about 2 and 5 millimeters.

4. The absorbent pad for pets, according to claim 1, wherein said elastic band is secured to said peripheral edges of said top and bottom layer with a predetermined separation distance between a peripheral edge of said middle layer and said elastic band.

5. The absorbent pad for pets, according to claim 1, wherein said predetermined percent open area of said top layer is between about 10 percent and 50 percent.

6. The absorbent pad for pets, according to claim 4, wherein said predetermined separation distance is greater than 3 inches.

7. The absorbent pad for pets, according to claim 1, wherein said apertures in said top layer have an equivalent diameter between about one-eighth and one-half inch.

8. The absorbent pad for pets, according to claim 1, wherein said liquid-impermeable film is polyethylene.
